(19) United States
(12) Patent Application Publication
(10) Pub. No.: US 2022/0141247 A1
(43) Pub. Date: May 5, 2022

(54) SYSTEMS AND METHODS FOR IDENTIFYING, REPORTING, AND ANALYZING THREATS AND VULNERABILITIES ASSOCIATED WITH REMOTE NETWORK DEVICES

(71) Applicant: Cyber Reconnaissance, Inc., Tempe, AZ (US)

(72) Inventors: Paulo Shakarian, Tempe, AZ (US); Jana Shakarian, Tempe, AZ (US); Jacob Cox, Tempe, AZ (US); Tirth Shah, Tempe, AZ (US)

(21) Appl. No.: 17/516,440

(22) Filed: Nov. 1, 2021

Related U.S. Application Data
(60) Provisional application No. 63/107,866, filed on Oct. 30, 2020.

(51) Int. Cl. H04L 9/40; G06F 8/75

(52) U.S. Cl. CPC H04L 63/1433; G06F 8/75

(57) ABSTRACT

Embodiments of a computer-implemented system and methods for identifying and analyzing cyber threats and associated vulnerabilities associated with implementation of remote network devices are disclosed.

### CROSS-REFERENCE TO RELATED APPLICATIONS

This U.S. non-provisional patent application claims the benefit of provisional patent application No. 63/107,866 filed on Oct. 30, 2020, which is hereby incorporated by reference to its entirety.

### FIELD

The present disclosure generally relates to predictive cyber technologies; and in particular, to systems and methods for identifying and analyzing possible vulnerabilities and associated threats associated with remote network devices.

### BACKGROUND

An increasing number of software (and hardware) vulnerabilities are discovered and publicly disclosed every year. In 2016 alone, more than 10,000 vulnerability identifiers were assigned and at least 6,000 were publicly disclosed by the National Institute of Standards and Technology (NIST). Once the vulnerabilities are disclosed publicly, the likelihood of those vulnerabilities being exploited increases. With limited resources, organizations often look to prioritize which vulnerabilities to patch by assessing the impact it will have on the organization if exploited. Standard risk assessment systems such as Common Vulnerability Scoring System (CVSS), Microsoft Exploitability Index, Adobe Priority Rating report many vulnerabilities as severe and will be exploited to err on the side of caution. This does not alleviate the problem much since the majority of the flagged vulnerabilities will not be attacked.

NIST provides the National Vulnerability Database (NVD) which comprises of a comprehensive list of vulnerabilities disclosed, but only a small fraction of those vulnerabilities (less than 3%) are found to be exploited in the wild—a result confirmed in the present disclosure. Further, it has been found that the CVSS score provided by NIST is not an effective predictor of vulnerabilities being exploited.

It is with these observations in mind, among others, that various aspects of the present disclosure were conceived and developed.

### BRIEF DESCRIPTION OF THE DRAWINGS

FIG. 1 is a simplified block diagram showing a general computer-implemented system for identifying and analyzing cyber threats and associated vulnerabilities associated with one or more remote network devices.

FIG. 2A is an illustration of an embodiment of the system of FIG. 1 for accessing network device information.

FIG. 2B is an illustration of another embodiment of the system of FIG. 1 for accessing network device information.

FIG. 2C is an illustration of another embodiment of the system of FIG. 1 for accessing network device information.

FIG. 3 is an illustration of data aggregation for analyzing vulnerability data of a network device.

FIG. 4 is an illustration of augmentation of vulnerability data for network devices.

FIG. 5 is another illustration of augmentation of vulnerability data for network devices.

FIG. 6 is an exemplary computer-implemented method for identifying and analyzing cyber threats and associated vulnerabilities associated with one or more remote network devices.

FIG. 7 is an exemplary simplified diagram of a computing device that may be configured to implement various methodologies described herein.

Corresponding reference characters indicate corresponding elements among the view of the drawings. The headings used in the figures do not limit the scope of the claims.

### DETAILED DESCRIPTION

Remote users (i.e. users working from home) pose a significant threat to enterprise networks due to vulnerable network devices at the remote location (i.e. a wireless router residing at the home). Aspects of the present disclosure relate to embodiments of a system that enumerates the network devices at the location of the remote user along with key metadata (i.e. vulnerabilities) in addition to analysis of this metadata to align with information about threats (i.e. potential for malware and exploit usage against such devices by hackers) and obtaining an understanding of the overall risk (i.e. examining aggregate statistics on the devices residing at the remote users) in order to driver policy (i.e. automatically blocking users with certain devices or the purchase of standardized network devices for remote users).

In some embodiments of the system, network device information is provided from the remote user. In other embodiments, network device information is interrogated or otherwise accessed without manual input by the remote user (via external or internal measures). It should be appreciated that features of the present embodiments may be common to one or more other embodiments; i.e., features of the embodiments are not mutually exclusive, and different variations of the embodiments are contemplated.

### Introduction and Technical Challenges

### Definitions:

Network devices: A network device as referenced herein refers to one or more hardware devices or elements used to connect computing devices to a larger network and can include, by non-limiting examples, routers, switches, hubs, wireless access points, repeaters, modems, and the like.

Vulnerability: The term vulnerability as used herein may include a piece of software, hardware, or software/hardware combinations, that can be exploited by a hacking actor to perform unauthorized actions that are considered to be violating the confidentiality, integrity, or availability policies of a computing system hosting or executing the technology (software and/or hardware) having the vulnerability susceptible to exploit. Further, the term “vulnerability” can also be used to refer to a class of vulnerabilities and may not only include software flaws (may also include hardware or software/hardware combinations), but other flaws including but not limited to misconfigurations, to organizational practices, hardware, and physical security. It can also be used to describe a class of generalized computer issues that appeal to particular hackers or communities of hackers for purposes of compromising computer systems.

Vulnerability Exploitation: This term refers to an act of taking advantage of a software (and/or hardware) flaw within a computer system. Vulnerability exploitation is often performed using a piece of software, or a sequence of input data, known as an “exploit”.

Proof-Of-Concept (PoC) exploits: This term refers to non-malicious exploits that are developed only to demonstrate how hackers can take advantage of certain software (and/or hardware) flaws. Malicious hackers may leverage PoC exploits to craft weaponized, harmful exploits.

Hacking actors: This term refers to individuals who engage in activities related to software hacking, either with malicious (a.k.a., black-hat hackers) or non-malicious intent (a.k.a., white-hat hackers).

Online hacker communities: This term refers to online environments used by hackers around the globe, such as Chan sites, social media, paste sites, grey-hat communities, Tor, surface web, and even highly access-restricted sites.

Common Vulnerability and Exposure (CVE): This term refers to a unique identifier assigned to each software vulnerability in the National Vulnerability Database (NVD) maintained by the National Institute of Standards and Technology (NIST). The CVE numbering system associated with the NISD follows one of these two formats:
CVE-YYYY-NNNN; and
CVE-YYYY-NNNNNNN.

The “YYYY” portion of the identifier indicates the year in which the software flaw is reported, and the N's portion is an integer that identifies a flaw (e.g., see CVE-2018-4917 related to https://nvd.nist.gov/vuln/detail/CVE-2018-4917, and CVE-2019-9896 related to https://nvd.nist.gov/vuln/detail/CVE-2019-9896).

Common Platform Enumeration (CPE): A Common Platform Enumeration, or CPE, relates to a list of software/hardware products that are vulnerable to a given CVE. The CVE and the respected platforms that are affected, i.e., CPE data, can be obtained from the NVD. For example, the following CPEs are some of the CPEs vulnerable to CVE-2018-4917:
cpe:2.3:a:adobe:acrobat_2017:*:*:*:*:*:*:*:*
cpe:2.3:a:adobe:acrobat_reader_dc:15.006.30033:*:*:*:clas sic:*:*:*
cpe:2.3:a:adobe:acrobat_reader_dc:15.006,30060:*:*:*:clas sic:*:*:*

Common vulnerability scoring system (CVSS): This term refers to a scoring system that captures the severity level of software vulnerabilities based on the technical characteristics such as the ease of exploitation and an approximation of impact it would leave if it is exploited. CVSS ranges from 0 to 10 (the most severe score). The CVSS base score is computed from the CVSS base vector, which is composed of two sub-scores, the Exploitability metrics and the Impact metrics. Each sub-score measures different technical characteristics related to the vulnerability. For example, the Exploitability metrics includes the Attack Vector metric, which explains how a vulnerability can be exploited. It can take one of the values: Network, Adjacent, Local, or Physical.

Technical Challenges: Information technology (IT) administrators lack sufficient technical means for efficiently identifying and practically addressing possible vulnerabilities of a technology configuration such as determining how to approach a specific vulnerability (versus another). A given IT environment may be potentially susceptible to thousands of security vulnerabilities (at least those identifiable via the NVD). While the NVD and CVSS provides baseline information about some threats, there is insufficient technology presently available that might allow IT administrators to actually make sense of and intelligently leverage such information to apply responsive measures and prioritize patches or other fixes, and predict actual attacks based on the specifics of a given technology configuration.

In addition, it is technologically problematic and cumbersome to monitor devices of end users for the same possible vulnerabilities and exploits. Yet, network devices of end users having access to data of the IT environment may not be secure nor monitored or may otherwise be susceptible to attack or exploit. These issues are exacerbated during present times of increased remote work and data access during a pandemic.

### General Specifications of a Computer-Implemented System Responsive to Technical Challenges

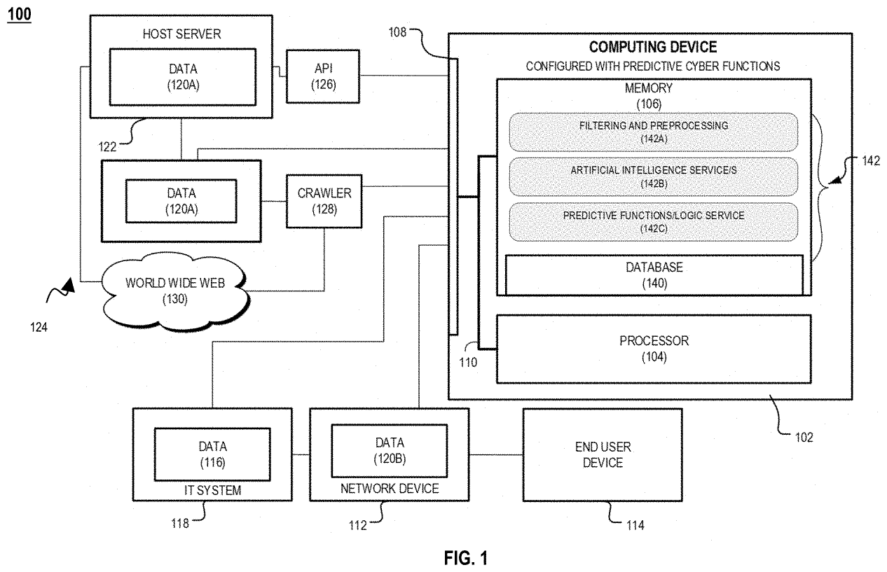

Referring to FIG. 1, an inventive concept responsive to the aforementioned technical challenges may take the form of a computer-implemented system, designated system 100, comprising any number of computing devices or processing elements. In general, the system 100 leverages artificial intelligence to implement cyber predictive methods to e.g., identify possible vulnerabilities of remote network devices associated with end users, and assess possible exploits thereof. While the present inventive concept is described primarily as an implementation of the system, it should be appreciated that the inventive concept may also take the form of tangible, non-transitory, computer-readable media having instructions encoded thereon and executable by a processor, and any number of methods related to embodiments of the system described herein. In some embodiments, the system 100 comprises (at least one of) a computing device 102 including a processor 104, a memory 106 of the computing device 102 (or separately implemented), a network interface (or multiple network interfaces) 108, and a bus 110 (or wireless medium) for interconnecting the aforementioned components. The network interface 108 includes the mechanical, electrical, and signaling circuitry for communicating data over links (e.g., wires or wireless links) within a network (e.g., the Internet). The network interface 108 may be configured to transmit and/or receive data using a variety of different communication protocols, as will be understood by those skilled in the art.

The system 100 further includes at least one network device 112 such as a router, modem, wireless access point, or combinations thereof, in operable communication with an end user device 114 such as a desktop computer, laptop, tablet, or mobile device, where the end user device 114 leverages the network device 112 to access data 116 of an IT system 118. In general, the computing device 102 is adapted to analyze and assess possible threats to the network device 112 and/or the IT system 118 arising from implementation of the network device 112, as further described herein. In some embodiments, the network device 112 and end user device 114 are remote from the IT system 118, and may represent a home/personal/remote computing environment of an end user accessing the data 116 outside of the IT system 118 via a VPN connection or otherwise; i.e., for example, the network device 112 may be owned by an end user (employee) associated with the IT system 118 and is not vetted, monitored, or part of an internal network (e.g., LAN) of the IT system 118 that would ordinarily be monitored and secured.

In general, via the network interface 108 or otherwise, the computing device 102 is adapted to access data 120 from one or more sources that is helpful for analyzing possible threats to or arising from implementation of the network device 112, and the data 120 may be generally stored/aggregated within a storage device (not shown) or locally stored within the memory 106 for further processing. For example, the computing device 102 is adapted to access a first portion of the data 120, data 120A, from the host server 122 or other remote computing device. The data 120A includes any information about hacker communications, information about cybersecurity events across multiple technology platforms referenced herein, information about known vulnerabilities associated with hardware and software components, any information from the NVD including updates. As shown, the computing device 102 may further be adapted to access the data 120A directly and/or indirectly from various data sources 124 (such as the deep or dark web (D2web), or the general Internet including hacking actors, hacking communities, or any sources of information related to hacking). In some embodiments, the computing device 102 accesses the data 120A by engaging an application programming interface 126 to establish a temporary communication link with the host server 122. Alternatively, or in combination, the computing device 102 may be configured to implement a crawler 128 (or spider or the like) to extract the data 120A from the data sources 124 without aid of a separate device (e.g., host server 122). Further, the computing device 102 may access the data 120 from any number or type of devices providing data via the general Internet or World Wide Web 130 as needed, with or without aid from a specific device such as the host server 122.

The computing device 102 is further adapted to receive or otherwise access another portion of the data 120, data 120B, which may include information about a technology configuration of the network device 112, i.e., hardware and software components/parameters associated with the network device 112 implemented by an end user to access data associated with some entity such as a company, and information about any vulnerabilities and possible related exploits thereof. A technology configuration may include firmware, software and may define software stacks and individual software applications/pieces, may include hardware, and the like.

The data 120 accessed may generally define or be organized into datasets or any predetermined data structures which may be aggregated or accessed by the computing device 102 and may be organized within a database 140 stored in the memory 106 or otherwise stored. Once this data is accessed and/or stored in the database 140, the processor 104 is operable to execute a plurality of services 142, encoded as instructions within the memory 106 and executable by the processor 104, to process the data so as to determine correlations and generate rules or predictive functions, as further described herein. The services 142 of the system 100 may generally include, without limitation, a filtering and preprocessing service 142A for, in general preparing the data 120 for machine learning or further use; an artificial service 142B comprising any number or type of artificial intelligence functions for modeling the data 120 (e.g., natural language processing, classification, neural networks, linear regression, etc.) and/or feature extraction and any other related methods; and a predictive functions/logic service 142C that formulates predictive functions and outputs one or more values suitable for reducing risk, such as a probability that the network device 112 is susceptible to a given exploit based on, e.g., firmware or other aspects of the network device 112. The plurality of services 142 may include any number of components or modules executed by the processor 104 or otherwise implemented. Accordingly, in some embodiments, one or more of the plurality of services 142 may be implemented as code and/or machine-executable instructions executable by the processor 104 that may represent one or more of a procedure, a function, a subprogram, a program, a routine, a subroutine, a module, an object, a software package, a class, or any combination of instructions, data structures, or program statements, and the like. In other words, one or more of the plurality of services 142 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 106), and the processor 104 performs the tasks defined by the code.

### Exemplary Embodiments of the System (100) for Accessing and Analyzing Network Device Information

Given the above information, various embodiments and sub-embodiments of the system 100 shall now be described that are responsive to the technical challenges set forth herein. It should be appreciated that the embodiments of the system 100 are not mutually exclusive such that the system 100 may be configured using any number or type of features described for each embodiment (i.e., embodiments may share features), and/or may be configured with select features of various embodiments for specific applications. In general, under the following embodiments of the system 100, the computing device 102 is adapted to access information about vulnerabilities and corresponding exploits (data 120A) of a plurality of different network devices based on hardware, software, or combinations thereof. This is informative as to what network devices are susceptible to one or more types of cyber threats, and why. The computing device 102 is further adapted to access information about a specific network device 112 for analysis including hardware or software configurations of the device (data 120B), and to identify possible risk to implementation of the network device 112 based on the data 120A informing as to known vulnerabilities and exploits.

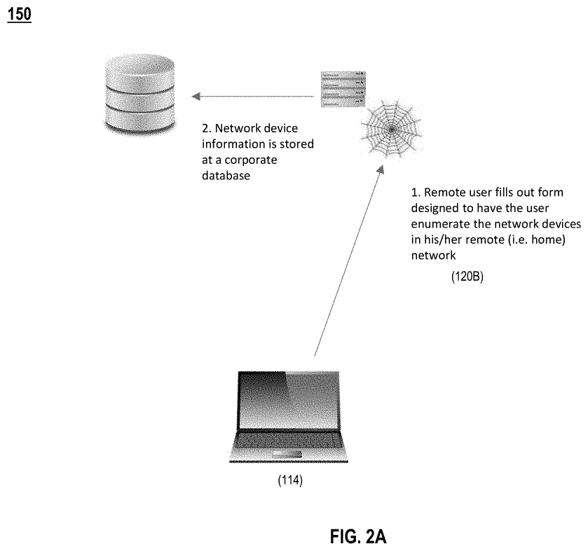

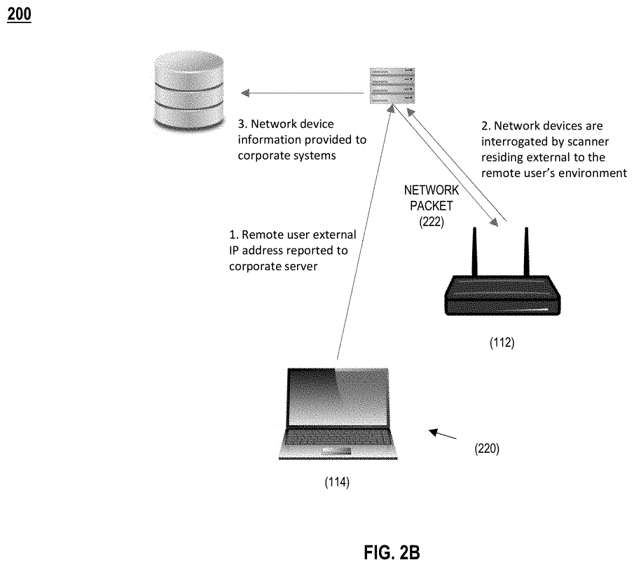

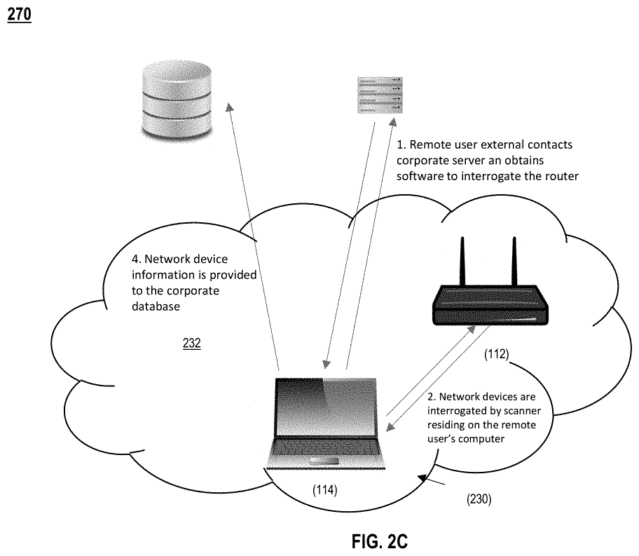

Referring to FIG. 2A, in a first embodiment 150 of the system 100, a remote user (implementing the end user device 114) automatically provides the computing device 102 with access to information regarding the make/model, software versions, firmware versions, and/or vulnerability information of the network device 112 or other network equipment within a remote (for example home) environment where the end user device 114 is being implemented to access aspects of the data 116 from the IT system 118. Note that in this embodiment, vulnerability information of the network device 112 is broadly defined to not only include (but not limited to) standard hardware or software vulnerabilities, vulnerabilities disclosed by the manufacturer or other authority, vulnerabilities found through automatic means not previously disclosed, but also vulnerabilities due to misconfigurations, configurations outside of well-accepted best-practices, and poor/non-existent default passwords. This data, data 120B, is then reported to the computing device 102 or an administrator of the IT system 118.

Various sub-embodiments of the embodiment 150 of the system 100 are contemplated. As one exemplary sub-embodiment, a user logs into a “network device survey tool” and manually enters information on the make/model, software versions, firmware versions, and/or vulnerability information of the network device 112 or other network equipment within the remote (for example home) environment. The “network device survey tool” can be web-based, terminal-based, available as a fillable database form, or based on a locally running application (i.e. an app for Android or Apple IOS). The form may include selectable items (i.e. a drop-down list or similar graphical widget) in order to ensure the aforementioned data is properly formatted. This survey data is then transmitted or otherwise made accessible to the computing device 102.

Referring to FIG. 2B, another embodiment (200) of the system 100 is illustrated. In this example, as indicated, software (220) may be implemented (via the computing device 114) that obtains the external IP address of the network device 112 or other network device(s) and then runs an external scan on the device to obtain the make/model, software versions, firmware versions, and/or vulnerability information on the device(s). Also note that the external IP address can be obtained from several means: for instance, it can be obtained by tracing the route of a network packet (222) that is inbound or outbound from the remote user. Another method of the present embodiment 200 of the system 100 involves mapping the corporate systems (IT system 130), examining the IP addresses that connect to the corporate systems, and then running the scan (as defined in this embodiment) to identify possible vulnerabilities of the scanned devices.

In one version of the present embodiment (200), the remote user's machine, end user device 114, initiates a scanner running on a container in a corporate network that, in-turn runs a vulnerability scan of the remote user's external IP address. The results of the scan are then reported to the corporate security team.

Yet another variant of the present embodiment would be to use a SaaS-based solution to scan the external IP address of the network device 112 and not necessarily rely on a container. The external IP address would be reported to the SaaS-based vulnerability scanner and the scanning process is automatically started. Alternatively, a non-container-based and non-SaaS based scanner solution but based on a computer system (i.e. an appliance-based scanner solution) is initiated in the same manner as a SaaS based scanning solution.

In a different version of the embodiment (200), scanning software (shown as 220) is downloaded to the user's machine and the scanner is then run on the remote user's machine but pointed to the external IP address.

In a different version of this embodiment, a system for external scanning can grab basic information from the network device 112 (i.e. banner information). This can be executed either from a process running on the corporate entity (i.e. a container) or run from the remote user's machine.

Referring to FIG. 2C, in another embodiment 270 of the system 100, software (230) that obtains the internal IP address of the network device 112 or other network device(s) may be implemented by any computing device (e.g., computing device 114) to run an external scan on the network device 112 in order to obtain the make/model, software versions, firmware versions, and/or vulnerability information of the device(s). Here, for example, scanning software (230) is downloaded to a computer on the remote user's network (e.g., computing device 114) and the software 230 interrogates the network device(s) 112 in the remote user's network (232) to obtain the data.

### Aggregating and Analyzing Vulnerability Data on the Network Device (112)

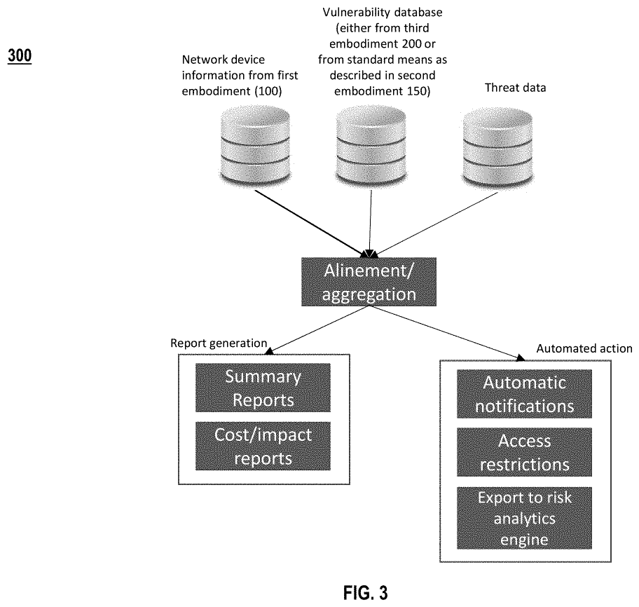

Referring to an embodiment 300 of the system 100 shown in FIG. 3, it is contemplated that multiple network devices (112) may be analyzed to assess possible risk to implementation of these devices. For each distinct network device 112 (i.e. wireless router) reported by the remote user(s) as through the technology described in the previous embodiments (e.g., embodiment 150), it is assumed that there is an entry in a corporate database or otherwise stored providing, at a minimum, the IP address, remote user, and the make and model of each of a plurality of network devices 112 being remotely implemented.

If vulnerability information for a given network device 112 is not provided by the techniques of the first embodiment 150, the make and model of the network device 112 may be further mapped to vulnerability information using a vulnerability database such as NIST NVD, Vulners, CNVD, VulnDB, or others. As with the first embodiment 150, note that vulnerability information is broadly defined to not only include (but not limited to) standard hardware or software vulnerabilities, vulnerabilities disclosed by the manufacturer or other authority, vulnerabilities found through automatic means not previously disclosed, but also vulnerabilities due to misconfigurations, configurations outside of well-accepted best-practices, and poor/non-existent default passwords.

Once vulnerability information is added to each device entry, the vulnerability information is then further mapped to external threat intelligence information which can include, but is not limited to exploit information sources (to include proof-of-concept sources) like Metasploit, ExploitDB, and Canvas; threat intelligence information such as that obtained from services such as CYR3CON, RecordedFuture, or other intelligence sources either directly (i.e. using technology that aligns intelligence with vulnerability information) or indirectly (i.e. using searches, regular expressions, or machine learning to align intelligence with vulnerability information).

Additionally, vulnerability information may be aligned with vulnerability scoring information which may include (but not limited to) NIST CVSS scoring; scoring derived from vulnerability scanning software such as Qualys, Tenable, Nessus, or Rapid7; scoring derived from threat intelligence either directly included with the threat intelligence information (i.e. as per CYR3CON); provided by a query over the intelligence information (i.e. number of exploits, number of hacker discussions, etc.); or created through the use of machine learning.

Upon the alignment of the information with vulnerability, intelligence, and scoring data as specified above, the database can then be configured to provide a series of reports. Sub-embodiments of such reports include (but are not limited to):
1. Sub-Embodiment: Report on network devices in remote environments for which there exists a known exploit.
2. Sub-Embodiment: Report on devices in remote environments for which there is likely to have a known exploit.
3. Sub-Embodiment: Report of devices in remote environments that are no longer supported by the manufacturer.
4. Sub-Embodiment: Report of devices in remote environments for which there exist specific vulnerabilities (i.e. such as use of default passwords, use of WPS, etc.)

Based on these reports, additional queries can produce reports that directly support security-related decisions, which can include (but are not limited to) the following:
1. Estimates of the potential cost of cyber-attacks resulting from insecure network devices in the remote locations.
2. Lists of remote networks whose network devices pose extremely dangerous risk to the corporate network

Further, such results can be integrated with other systems, for example:
1. Users from remote networks with high-risk devices can be limited into which parts of the corporate network they can interact with and may be precluded from access all-together. As these results are a machine-readable direct output of the system, they can be used as input to other systems such as VPN's, firewalls, or access control systems to limit or prevent access.
2. Automatic notifications to users in at-risk remote environments (as determined by the output of the system in this embodiment) that may include (but are not limited to) web-based alerts, email-alerts, and messages within collaborative software (i.e. Microsoft Teams, Slack, Mattermost). Such alerts would inform users they must remediate deficiencies on their network devices in a certain time period or their access to the corporate network will be limited or revoked.
3. Using the output of this system to other systems used to compute cyber risk and/or align with common cybersecurity risk frameworks such as those provided by NIST or CI Security.

### Augmenting Vulnerability Information for the Network Device (112)

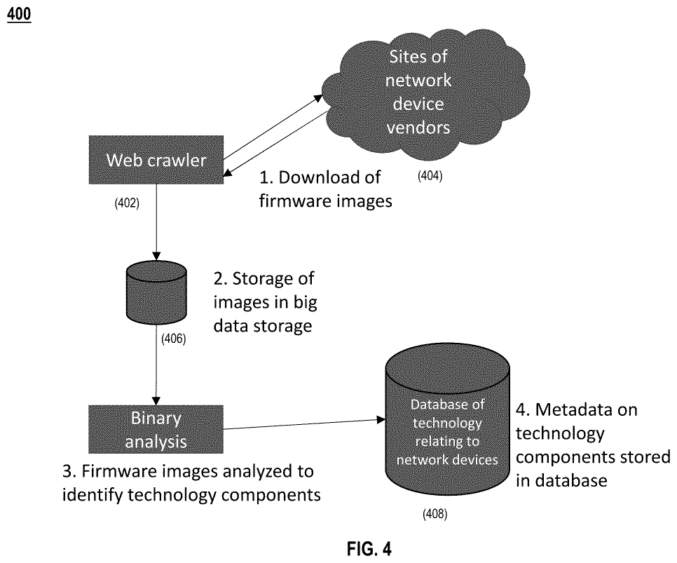

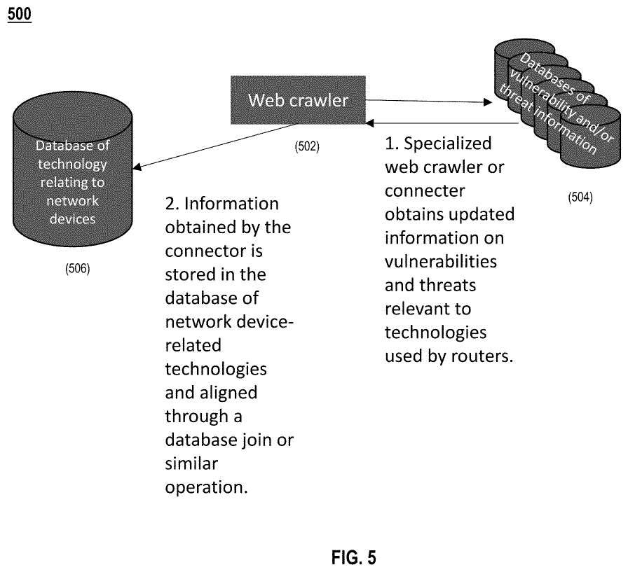

Referring to FIGS. 4 and 5, the previous embodiments above and features generally relate to mapping of parameters of a network device 112 such as the make and or model information of the network device 112 to technology vulnerabilities. However, in reality, not all vulnerabilities associated with the network devices 112 may be catalogued or identifiable in a vulnerability scanner. Hence, evaluation of the firmware of the network device 112 may be required to further identify any technology components (i.e. operating system, software, etc.) and vulnerabilities (i.e. hard coded passwords) are present in on a given network device 112.

Embodiment 400 of FIG. 4 illustrates a variation of the system 100 for obtaining and analyzing images of network device firmware. In this embodiment 400, the system 100 includes a web-crawler 112 that is focused on the websites of major network device manufacturers and designed to identify pages that host firmware images for the network device 112. The crawler would then automatically download the firmware images from devices 404 of the websites of the major network manufacturers to a data store. Subsequent to the download of the images, binary analysis on the images could then be conducted to extract necessary metadata (i.e. a component tool such as IDAPro or FACT could be used in this step). From the binary analysis of the firmware, metadata extracted from the analytical process would then be stored in a database 406. This metadata would focus on the technology components used within the network device, such as operating system type and version. The metadata is in-turn stored in a database 408.

Embodiment 500 of FIG. 5 illustrates yet another variation of the system 100 suitable for maintenance of vulnerability and threat information to network devices. As indicated, a web crawler 502 connects to databases 504 of vulnerability and threat information is set to identify vulnerability and threat information relevant to the technology identified as running on network devices for which information is stored in the database from embodiment 400. The information on threats and vulnerabilities is then stored in the database 506 that contains data about router technologies. This data may then be aligned with the information relating to network device technologies through a database join, query, or similar operation.

The database resulting from embodiment 400 can then be leveraged with the embodiment 200 that leverages a vulnerability database that maps the make/model of a network device 112 to vulnerabilities. The embodiment 300 can be used to either augment or replace such database.

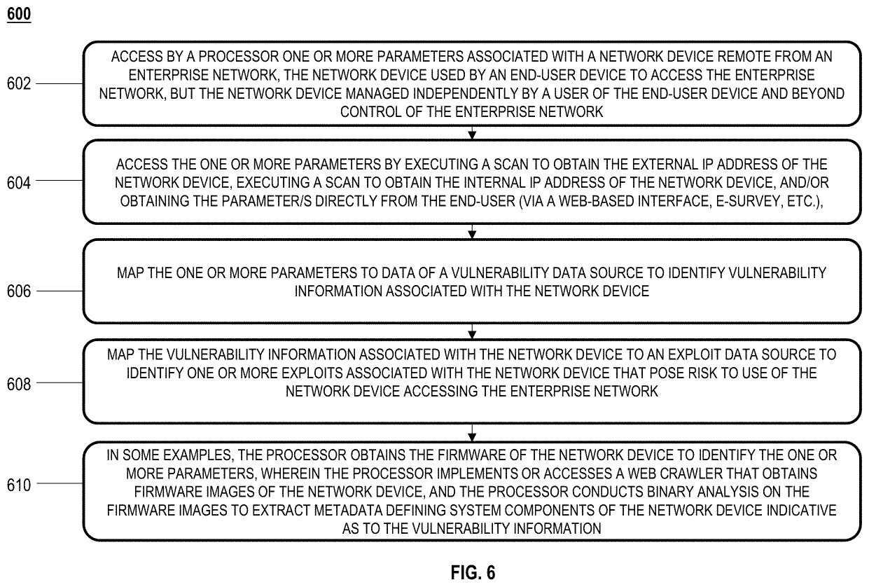

Referring to FIG. 6, an exemplary computer-implemented method 600 is illustrated, executable by the computing device 102 or other devices or processing elements. In general, referring to block 602, a processor (e.g., processor 104) accesses the one or more parameters set forth above associated with a network device 112. The one or more parameters include, by non-limiting examples, a make/model of the device, software versions running on the network device 112, firmware versions, and/or known or predetermined vulnerability information associated with the network device 112. The one or more parameters further includes any information about configurations of the network device 112, including password configurations, faulty or the absence of passwords, and the like.

Referring to block 604 of method 600, the processor 104 is configured to access the one or more parameters in at least one of a variety of different forms. In one example, the processor 104 is configured to access an external IP address of the network device 112, and further configured to execute or access results of a scan of the network device 112 using the external IP address. The external IP address can be obtained by one of at least several methods: for instance, it can be obtained by tracing the route of a network packet that is inbound or outbound from the remote user. Another method would involve mapping the corporate systems (of the enterprise network) and examining the IP addresses that connect to the corporate systems and then running the scan. Various container-based and non-container-based versions of conducting the scan are described herein.

In another example, the processor 104 is configured to access an internal IP address of the network device 112, and further configured to execute or access results of a scan of the network device 112 using the internal IP address. Here, scanning software is downloaded to a computer on the remote user's network (that includes the network device 112) and the software interrogates the network device 112 in the remoter user's network to obtain the one or more parameters. Block 604 also acknowledges that the one or more parameters may be retrieved directly from an end-user operating the network device 112.

Referring to block 606, the one or more parameters are leveraged to identify any cyber risks to operation of the network device 112, and to the enterprise network. In particular, the one or more parameters may be mapped to data of a vulnerability data source to identify vulnerability information. For example, referencing a make/model of the network device 112 of the one or more parameters, it may be determined by mapping or other such methods that a vulnerability data source, such as the NIST NVD, Vulners, CNVD, VulnDB, or others, identifies vulnerability information related to the network device 112 based such make or model of the device; in other words, it may be revealed by the data source that a network device with a given make and model is susceptible to a vulnerability.

Moving to block 608, the processor 104 is further configured to map the vulnerability information of the network device 112 to one or more exploits by leveraging at least one exploit data source, such as Metasploit, ExploitDB, and Canvas. The mapping can be conducted either directly (i.e. using technology that aligns intelligence with vulnerability information) or indirectly (i.e. using searches, regular expressions, or machine learning to align intelligence with vulnerability information). In addition, vulnerability information may be aligned with vulnerability scoring information which may include (but not limited to) NIST CVSS scoring; scoring derived from vulnerability scanning software such as Qualys, Tenable, Nessus, or Rapid7; scoring derived from threat intelligence either directly included with the threat intelligence information (i.e. as per CYR3CON); provided by a query over the intelligence information (i.e. number of exploits, number of hacker discussions, etc.); or created through the use of machine learning.

As indicated in block 610, in some examples, the processor 104 obtains the firmware of the network device to identify the one or more parameters, wherein the processor implements or accesses a web crawler that obtains firmware images of the network device, and the processor conducts binary analysis on the firmware images to extract metadata defining system components of the network device indicative as to the vulnerability information.

### Exemplary Computing Device

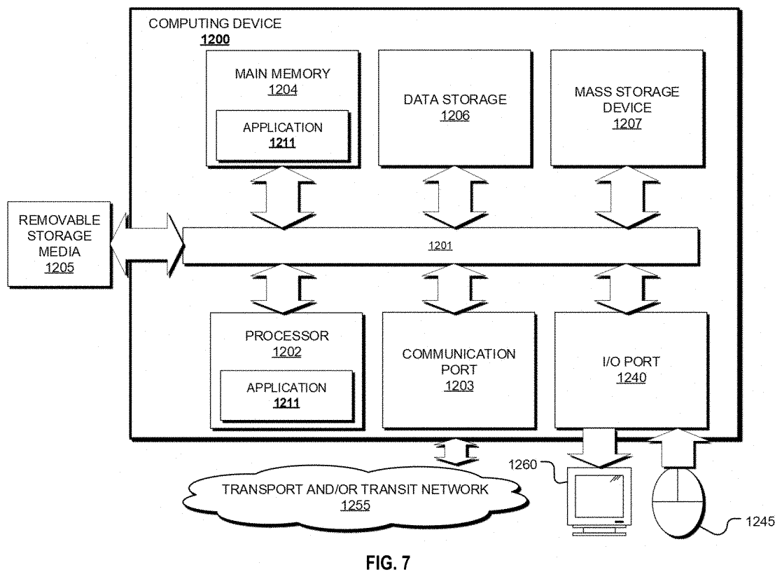

Referring to FIG. 7, a computing device 1200 is illustrated which may take the place of the computing device 102 and be configured, via one or more of an application 1211 or computer-executable instructions, to execute functionality described herein. More particularly, in some embodiments, aspects of the predictive methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for assessing cyber threats associated with network devices, comprising:
a network interface that communicates with one or more of a network; and
a processor in operable communication with the network interface to access information via the network interface, the processor configured to execute a set of instructions, to:
access, by the processor, parameters of a network device defining a hardware or software configuration of the network device to analyze threats to an IT system associated with the network device.

2. The system of claim 1, wherein the processor is adapted to execute, externally, a scan of the network device to identify an IP address of the network device and identify software or firmware of the network device based on the IP address to assess vulnerabilities thereof.

3. The system of claim 1, wherein the processor is adapted to identify an internal IP address of the network device to identify the parameters, by accessing a scan of the network device conducted at a computing device connected to a local network of the network device.

4. The system of claim 1, wherein the set of instructions is further executable by the processor to:
access, by the processor, vulnerability information defining hardware and/or software configurations of one or more network devices mapped to one or more vulnerabilities, and
compare the vulnerability information with the parameters to identify a vulnerability of the network device.

5. The system of claim 1, wherein the processor is further adapted to execute a crawler to identify firmware of the network device from a manufacturer web page.

6. The system of claim 1, wherein the processor is further adapted to download images from the website, conduct binary analysis of the images to extract metadata, the metadata directed to technology components of the network device including an operating system.

7. A method for assessing cyber threats associated with network devices, comprising:
accessing, by a processor, one or more parameters of a network device remote from an enterprise network;
mapping by the processor the one or more parameters of the network device to vulnerability information associated with a vulnerability database; and
mapping by the processor the vulnerability information to external threat intelligence from one or more predetermined exploit information data sources to identify one or more exploits associated with the network device.

8. The method of claim 7, further comprising:
receiving from a computing device associated with an end-user, the one or more parameters of the network device by a scan of an external IP address of the network device.

9. The method of claim 8, wherein the scan of the external IP address is conducted by a scanner running on a container within the enterprise network that executes a vulnerability scan of the external IP address.

10. The method of claim 8, wherein the scan of the external IP address is conducted using a SaaS-based vulnerability scanner devoid of a container.

11. The method of claim 8, wherein the scan of the external IP address is conducted using scanning software downloaded to the computing device associated with the end user such that the scan is run on the computing device but pointed to the external IP address.

12. The method of claim 8, wherein the scan of the external IP address is conducted includes grabbing banner information from the network device.

12. (canceled)

13. The method of claim 7, further comprising augmenting the vulnerability information, including:
analyzing, by the processor, firmware of the network device to identify the one or more parameters, including:
implementing a web-crawler configured to identify pages that host firmware images for the network device,
downloading the firmware images to a data store,
conducting, by the processor, binary analysis on the firmware images to extract metadata for storage and retrieval, the metadata defining operating system components of the network device.

14. The method of claim 7, further comprising augmenting the vulnerability information, including:
analyzing, by the processor, firmware of the network device to identify the one or more parameters, including:
accessing vulnerability and threat information associated with the network device as retrieved by a web crawler, and
aligning the vulnerability and threat information with the one or more parameters of the network device through a database operation.

15. A tangible, non-transitory, computer-readable media having instructions encoded thereon, the instructions, when executed by a processor, being operable to:
access one or more parameters of a network device remote from an enterprise network;
map the one or more parameters of the network device to vulnerability information associated with a vulnerability database; and
map the vulnerability information to external threat intelligence from one or more predetermined exploit information data sources to identify one or more exploits associated with the network device.

16. The tangible, non-transitory, computer-readable media of claim 15, wherein the instructions, when executed by the processor, are further operable to:
receive from a computing device associated with an end-user, the one or more parameters of the network device by a scan of an external IP address of the network device.

17. The tangible, non-transitory, computer-readable media of claim 15, wherein the instructions, when executed by the processor, are further operable to:
receive from a computing device associated with an end-user, the one or more parameters of the network device by a scan of an internal IP address of the network device.

18. The tangible, non-transitory, computer-readable media of claim 15, wherein the instructions, when executed by the processor, are further operable to:
analyze firmware of the network device to identify the one or more parameters, by:
implementing a web-crawler configured to identify pages that host firmware images for the network device,
downloading the firmware images to a data store,
conducting, by the processor, binary analysis on the firmware images to extract metadata for storage and retrieval, the metadata defining operating system components of the network device.

19. The tangible, non-transitory, computer-readable media of claim 15, wherein the instructions, when executed by the processor, are further operable to:
estimate a potential cost of a cyber-attack resulting from the network device based upon the one or more exploits.

20. The tangible, non-transitory, computer-readable media of claim 15, wherein the instructions, when executed by the processor, are further operable to:
flag the network device as being associated with a risk, and
limit access to the enterprise network based upon the risk.
